(19) United States
(12) Patent Application Publication
(10) Pub. No.: US 2010/0273079 A1
(43) Pub. Date: Oct. 28, 2010

(54) Fuel Cell Drive for a Motor Vehicle

(75) Inventors: Gert Hinsenkamp, Esslingen (DE); Thomas Soczka-Guth, Schelklingen (DE); Norbert Wiesheu, Guenzburg (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/742,846

(22) PCT Filed: Oct. 28, 2008
(86) PCT No.: PCT/EP2008/009082

§ 371 Date: Jul. 14, 2010

(30) Foreign Application Priority Data
Nov. 14, 2007 (DE) 10 2007 054 246.3

(51) Int. Cl. H01M 8/04

(52) U.S. Cl. 429/442

(57) ABSTRACT

The invention relates to a fuel cell drive for a motor vehicle, in particular a utility vehicle, with a fuel cell assembly (1) as an energy source and a fuel cell cooling assembly (2) for adjustably cooling the fuel cell assembly (1) in dependence on the load. The fuel cell assembly (1) comprises at least two fuel cell units (3.1, 3.2) that can be controlled independently from each with a number of fuel cells that are connected in series. The fuel cell cooling assembly (2) comprises, for each of said fuel cell units (3.1, 3.2), an individual fuel cell cooling unit (4.1, 4.2) by means of which the fuel cells of the respective fuel cell unit (3.1, 3.2) can be cooled in dependence on at least one control variable.

The invention relates to a fuel cell drive for a motor vehicle, in particular a utility vehicle.

In DE 10 2004 037 901 A1 is suggested a fuel cell assembly with a fuel cell unit for generating electrical current and/or thermal heat and a cooling device for cooling the fuel cell unit. The cooling device thereby has at least one flow generator for generating a flow of a first cooling fluid, in particular a cooling water, and a second flow generator for generating a flow of a second cooling fluid, in particular a cooling water, and a second flow generator for generating a flow of a second cooling fluid, in particular a cooling air. The cooling device effects an efficient temperature control of the fuel cell unit. A control unit is provided for this for comparing a first operating parameter or a change of the first operating parameter of the first flow generator with a second operating parameter or a change of the second operating parameter of the second flow generator. The operating parameters of the flow generators are thereby preferably a power or a speed and/or a cooling fluid flow. By means of the comparison of the operating parameters or the change of the operating parameters of the two flow generators, a choice of the flow generator is provided, which operates more efficiently in dependence on the operating state or of the change of the operating state or discharges the waste heat more efficiently from the cooling circuit of the fuel cell unit than the other flow generator. It is intended thereby that the respective most efficient flow generator controls the temperature of the fuel cell unit by means of the control unit. The control unit is thereby formed for checking the first and/or the second operating parameter of the two flow generators preferably in dependence of at least one parameter or a change of the parameter of the fuel cell unit. The parameter or the change of the parameter of the fuel cell unit is for example a load or an electrical power output and/or a heat output.

The invention is based on the object to give a fuel cell drive for a motor vehicle, in particular a utility vehicle, whose fuel cells can be cooled in dependence on a load, so that they can be operated on a temperature level which is as constant as possible.

The object is solved according to the invention by an arrangement which has the characteristics given in claim 1.

Advantageous arrangements of the invention are the subject of the dependent claims.

The invention provides a fuel cell drive for a motor vehicle, in particular a utility vehicle, with a fuel cell assembly as an energy source and a fuel cell cooling assembly for the cooling of the fuel cell assembly in dependence on the load. The fuel cell assembly thereby comprises at least two fuel cell units that can be activated independently of each other with respectively a number of fuel cells connected in series, and the fuel cell cooling assembly comprises an individual fuel cell cooling unit for each of these fuel cell units, by means of which the fuel cells of the respective fuel cell unit can be cooled in dependence on at least one control variable. Suitable control variables are in particular at least a temperature of the respective fuel cell cooling unit and/or fuel cell unit.

The use of the fuel cell drive according to the invention is in particular advantageous for the drive of a utility vehicle, for example a bus. By means of the use of at least two independently activatable fuel cell units with respectively an individual controllable fuel cell cooling unit, the drive performance and the cooling of the fuel cell assembly can be adapted to the motor vehicle and the momentary drive situation in a flexible and cost-efficient manner. A utility vehicle requires for example a very high drive performance during the acceleration phases from standstill and during an uphill drive, which cannot be achieved with a presently available fuel cell unit, or which cannot be achieved in a cost-efficient manner. With a normal operation during a drive with a largely constant relatively low speed, a considerably lower drive performance isb needed in contrast.

The fuel cell drive according to the invention with at least two independently activatable fuel cell units with respectively an individual fuel cell cooling unit enables to fulfill a high and a low performance requirement with a respectively adapted cooling performance. This permits in particular to operate the motor vehicle with a number of fuel cell units adapted to the momentary performance requirement. The outage safety of the vehicle drive is thereby also increased, as the motor vehicle can be operated further with the or the remaining fuel cell units during an outage of one of the fuel cells.

By means of the variability of the cooling concept, electrical blower performance can additionally be saved, which increases the system efficiency.

The use of at least two fuel cell units is further effected in a positive manner due to a reduced piece number effect also with regard to the production costs.

In detail, the fuel cell cooling units preferably respectively comprise an individual coolant circuit with at least one circulating pump, at least one heat exchanger and at least one blower for each heat exchanger. The pumping capacitance of the at least one circulating pump and/or a speed of each blower can thereby be controlled in dependence on the at least one control variable.

The individual fuel cell cooling units for the individual fuel cells can thereby be controlled independently of each other, so that the respective associated fuel cell units can be cooled independently of each other an in dependence on the load.

The invention further provides that all components necessary for the operation of the fuel cell assembly, and which are to be cooled, with the exception of the fuel cells, for example converters, air compressors and electronic control units, can be cooled with a low temperature cooling assembly which is independent of the fuel cell cooling assembly. The fuel cell cooling assembly is thereby relieved on one hand, on the other hand, the total cooling assembly can be optimized with regard to performance and cost, as the low temperature cooling assembly can be adapted to the lower cooling performance requirement of the components to be cooled compared to the fuel cell cooling assembly to cooling components.

An advantageous arrangement of the fuel cell drive according to the invention provides that a waste heat of the fuel cell cooling assembly can be supplied to a heating circuit of the motor vehicle. This waste heat can be used thereby and the total efficiency of the fuel cell drive and of the heating circuit of the motor vehicle is increased.

A further advantageous arrangement of the fuel cell drive according to the invention provides that a number of electrical brake resistors for a brake of the motor vehicle can also be cooled by means of the fuel cell cooling assembly or the low temperature cooling assembly, for example of brake resistors, which are provided for the use og an energy supplied by a permanent brake and/or recuperation brake of the motor vehicle. This increases the efficiency of the system consisting of the vehicle drive and the brake system, as the fuel cell or the low temperature cooling assembly which is not needed during a braking process and thereby at times when the fuel cell drive is not needed, can be used for cooling the brake resistors.

Further advantages, characteristics and details of the invention are described in the following by means of embodiments with reference to the drawings. The drawings are schematic depictions and show:

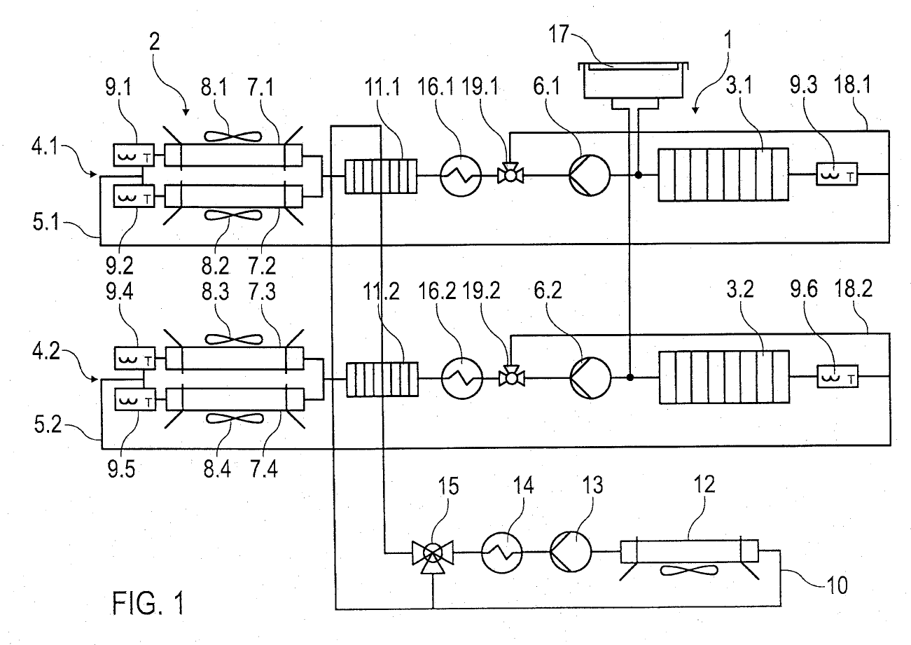

FIG. 1 a fuel cell assembly for a bus with two fuel cell units and a fuel cell cooling assembly with two fuel cell cooling units, which are coupled to a heating circuit and to brake resistors of a bus,

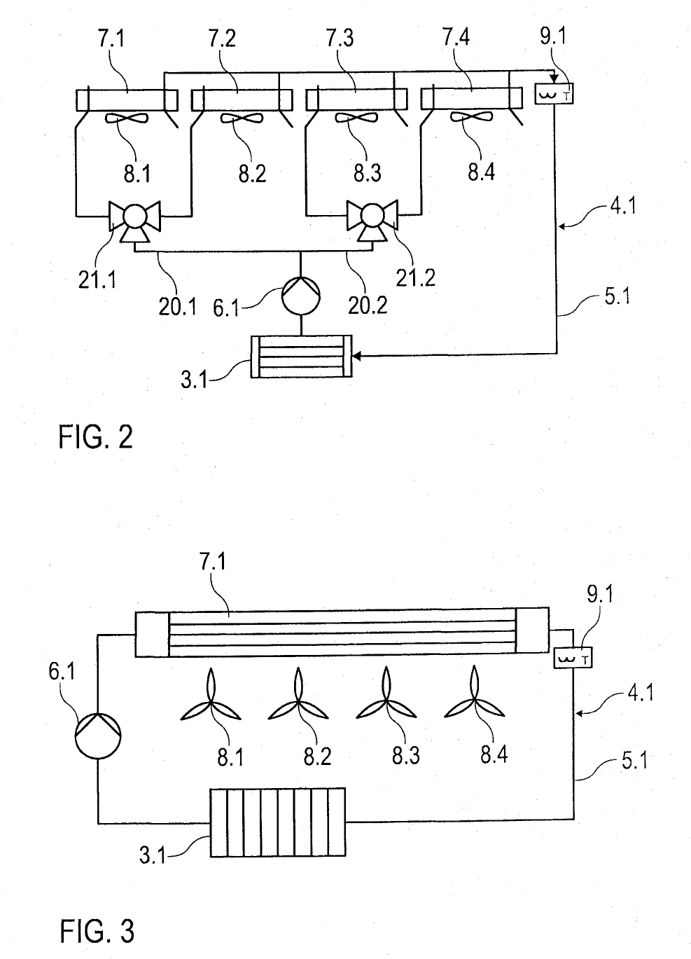

FIG. 2 a fuel cell unit and a fuel cell cooling unit with respectively four heat exchangers and blowers which can be connected independently, and

FIG. 3 a fuel cell unit and a fuel cell cooling unit with a heat exchanger and four blowers which can be connected independently.

Parts corresponding to each other are provided with the same reference numerals in all figures.

FIG. 1 shows a first embodiment of a fuel cell drive according to the invention for a bus with a fuel cell assembly 1 and a fuel cell cooling assembly 2, wherein the latter is coupled to a heating circuit 10 and to brake resistors 16.1, 16.2 of the bus.

The fuel cell assembly 1 comprises two fuel cell units 3.1 and 3.2 in this embodiment which can be activated independently of each other with respectively a number of fuel cells, which are connected in series to a so-called fuel cell stack.

The fuel cell cooling assembly 2 comprises an individual fuel cell cooling assembly 4.1 or 4.2 for each of the fuel cell units 3.1 and 3.2 for cooling the fuel cells of the respectively associated fuel cell unit 3.1, 3.2. Each fuel cell cooling unit 4.1, 4.2 comprises a coolant circuit 5.1, 5.2 for this, in which the respective associated fuel cell unit 3.1, 3.2 is present.

The coolant circuit 5.1 of the first fuel cell cooling unit 4.1 can be driven by a first circulating pump 6.1 and further comprises two heat exchangers 7.1 and 7.2 that can be flown through with a coolant in parallel. The coolant circuit 5.1 is divided into two branches for the parallel flow-through before the heat exchangers 7.1, and 7.2 and both branches are combined again behind the heat exchangers 7.1 and 7.2.

Each heat exchanger 7.1 and 7.2 is provided with an individual blower 8.1 or 8.2. Heated air can be discharged through the respective heat exchanger 7.1, 7.2 by means of the blowers 8.1, 8.2. This is already advantageous with low driving speeds of the bus, for example in the case of a city bus with a typical average speed of about 20 km/h, as an air flow generated with low driving speeds is not sufficient for a necessary discharge of the waste heat of the heat exchangers 7.1 and 7.2.

The coolant circuit 5.2 of the second fuel cell cooling unit 4.2 is designed in the same manner as the coolant circuit 5.1 of the first fuel cell cooling unit 4.1. It correspondingly comprises a second circulating pump 6.2 and two heat exchangers 7.3 and 7.4 which can be flown through in parallel with the coolant with respectively an individual blower 8.3 and 8.4.

The coolant circuits 5.1 and 5.2 are connected to a common balancing container 17 for the coolant, by means of which a volume change caused by a temperature of the coolant can be compensated in the coolant circuits 5.1 and 5.2 and the pressures can be controlled in the coolant circuits 5.1 and 5.2.

The fuel cell cooling units 4.1 or 4.2 are designed in such a manner that the cooling of the fuel cell units 3.1 and 3.2 can be controlled independently of each other. The pumping capacities of the circulating pumps 6.1 and 6.2 and the speeds of the blowers 8.1 to 8.4 can therefor respectively be adjusted independently of each other for this. Temperatures of the coolant are provided as control variables of each of the fuel cell units 3.1 and 3.2 at respectively three points within the respective coolant circuit 5.1, 5.2. The temperatures of the coolant are sensed for this in the first coolant circuit 5.1 by a first temperature sensor 9.1 behind the output of the first heat exchanger 7.1, by a second temperature sensor 9.2 behind the output of the second heat exchanger 7.2 and by a third temperature sensor 9.3 in front of the first fuel cell unit 3.1.

The pumping capacity of the first circulating pump 6.1 and/or the speeds of the first and second blowers 8.1 and 8.2 can be adjusted in dependence on these momentarily sensed temperatures, so that the temperature of the coolant remains at a constant predefinable level when entering the first fuel cell unit 3.1 and/or at the outputs of the first and second heat exchanger 7.1 and 7.2. For example, for each of these temperatures, a temperature interval can be predefined by a lower and an upper threshold by means of a control unit, and the pumping capacity of the first circulating pump 6.1 and/or the speeds of the first and second blowers 8.1 and 8.2 can be adjusted in such a manner that the temperature of the coolant remains within the respective temperature interval.

The cooling of the second fuel cell unit 3.2 can likewise be controlled by means of three temperature sensors 9.4 to 9.6 arranged in the second coolant circuit 5.2.

Alternatively or additionally to the temperatures of the coolant sensed by the temperature sensors 9.1 to 9.6, other or further control variables can be used for controlling the cooling of the fuel cell units 3.1 and 3.2. Such suitable control variables for the first fuel cell unit 3.1 are for example a temperature of the fuel cell unit 3.1 itself, and/or a temperature of the coolant at another or further point within the coolant circuit 5.1, e.g. at a point between the fuel cell unit 3.1 and the heat exchangers 7.1 and 7.2. Corresponding other or further control variables are suitable for the second coolant circuit 5.2.

The embodiment further provides a bypass 18.1, 18.2 in each of the coolant circuits 5.1 and 5.2, by means of which bypass a flowing coolant can be guided past the respective fuel cell unit. For diverting the coolant through the respective bypass 18.1, 18.2, an adjustable bypass valve 19.1, 19.2 is provided in the coolant circuits 5.1 and 5.2, by means of which a flow of the coolant through the respective fuel cell unit 3.1, 3.2 can be blocked depending on the position of the bypass valve. The cooling of each of the of the fuel cell units 3.1, 3.2 can thereby be prevented independently of each other, if a cooling of the respective fuel cell unit is not required or is not desired. The latter is for example advantageous with a cold start of the bus, in order to bring the fuel cell assembly quickly to an optimum operating temperature.

The coupling of the fuel cell cooling assembly 2 to the heating circuit 10 of the bus takes place via heat exchangers 11.1 and 11.2, by means of which a heat from the coolant circuits 5.1 and 5.2 can be supplied to the heating circuit 10. For this, the first heat exchanger 11.1 is arranged in the first coolant circuit 5.1 between the first fuel cell unit 3.1 and the heat exchangers 7.1 and 7.2, and the second heat exchanger 11.2 in the second coolant circuit 5.2 between the second fuel cell unit 3.2 and the heat exchangers 7.1 and 7.2. The heat exchangers 11.1 and 11.2 can further be coupled in series via a heating circuit bypass valve 15 to the heating circuit 10. The heating circuit 10 of the bus further comprises an internal bus heater 12, a heating circulating pump 13 and a heater 14.

By means of the fuel cell cooling assembly 2, brake resistors 16.1 and 16.2 for a brake of the bus, for example for an electromotive permanent brake and/or a recuperative brake can also be cooled in this embodiment. For this, the first brake resistor 16.1 is integrated into the first coolant circuit 5.1 and the second brake resistor 16.2 is integrated into the second coolant.

FIG. 2 shows an alternative embodiment of a fuel cell unit 3.1 with an individual fuel cell cooling unit 4.1 of a fuel cell drive according to the invention. The fuel cell cooling unit 4.1 comprises a coolant circuit 5.1, in which the fuel cell unit 3.1 is present and which can be driven with a circulating pump 6.1. Four heat exchangers 7.1 to 7.4 can be connected to the coolant circuit 5.1 independently of each other.

The coolant circuit 5.1 is divided into two coolant circuit branches 20.1 and 20.2 behind the circulating pump 6.1 for this. The first coolant circuit branch 20.1 can be connected to the first two heat exchangers 7.1 and 7.2 via a first adjustable three-way valve 21.1. Thereby, depending on the position of the three-way valve 21.1, either both heat exchangers 7.1 and 7.2 or only the first heat exchanger 7.2 or even none of the two heat exchangers 7.1 and 7.2 can be connected to the first coolant circuit branch 20.1.

The second coolant circuit branch 20.2 can correspondingly be connected either simultaneously to the third heat exchanger 7.3 and the fourth heat exchanger 7.4 or only to the third heat exchanger 7.3 or only to the fourth heat exchanger 7.4 or even to none of the two heat exchangers 7.3 and 7.4 via a second adjustable three-way valve 21.2 depending on its position.

The outputs of the heat exchangers 7.1 to 7.4 are connected to the fuel cell unit 3.1 via a common input, in which a temperature sensor 9.1 for sensing the coolant temperature is present.

Thereby, a coolant circuit 5.1 can be produced with an arbitrary combination of the heat exchangers 7.1 to 7.4 depending on the position of the three-way valves 19.1 and 19.2, and the coolant can be distributed thereon. An individual blower 8.1 to 8.4 is further provided for each of the heat exchangers 7.1 to 7.4, wherein the blowers 8.1 to 8.4 can be activated independently from each other.

The cooling of the fuel cell unit 3.1 can be controlled in dependence on the temperature of the coolant sensed by the temperature sensor 9.1 via the number of the heat exchangers 7.1 to 7.4 connected to the coolant circuit 5.1, the respective speed of the associated blowers 8.1 to 8.4 and/or the pumping capacity of the circulating pump 6.1.

FIG. 3 shows a third alternative embodiment of a fuel cell unit 3.1 with an individual fuel cell cooling unit 4.1 of a fuel cell drive according to the invention. The fuel cell unit 3.1 is in a coolant circuit 5.1 of the fuel cell cooling assembly 4.1 in this embodiment with a circulating pump 6.1 and a single heat exchanger 7.1, larger compared to the previously described embodiments. Four independently activatable blowers 8.1 to 8.4 are provided in this embodiment for the heat exchanger 7.1. A temperature sensor 9.1 for sensing the coolant temperature is further provided in the coolant circuit 5.1 behind the heat exchanger 7.1.

The heat exchanger 7.1 is for example dimensioned in this embodiment in that the fuel cell unit 3.1 can already be cooled sufficiently by a venting of the heat exchanger 7.1 by means of the air flow.

With a higher load of the fuel cell unit 3.1, the heat exchanger 7.1 can be vented by one or several of the blowers 8.1 to 8.4. The cooling of the fuel cell unit 3.1 can thereby be controlled as in the previously described embodiments in dependence on the coolant temperature sensed by the temperature sensor 9.1 via the number of the connected blowers 8.1 to 8.4, their respective speed and/or the pumping capacity of the circulating pump 6.1.

In the embodiments shown in FIGS. 2 and 3, for controlling the fuel cell unit 3.1, other or further control variables can be used alternatively or additionally to the temperature of the coolant sensed by the temperature sensor 9.1, for example a temperature of the fuel cell unit 3.1 itself and/or a temperature of the coolant at another or further point within the coolant circuit 5.1.

1. Fuel cell drive for a motor vehicle, in particular a utility vehicle, having a fuel cell assembly (1) as an energy source and a fuel cell cooling assembly (2) for adjustably cooling the fuel cell assembly (1) in dependence on the load, characterized in that
the fuel cell assembly (1). comprises at least two fuel cell units (3.1, 3.2) that can be activated independently from each other with respectively a number of fuel cells that are connected in series and that the fuel cell cooling assembly (2) comprises, for each of said fuel cell units (3.1, 3.2), an individual fuel cell cooling unit (4.1, 4.2), by means of which the fuel cells of the respective fuel cell unit (3.1, 3.2) can be cooled in dependence on at least one control variable.

2. Fuel cell drive according to claim 1, characterized in that
each of the fuel cell cooling units (4.1, 4.2) comprises a coolant circuit (5.1, 5.2) with at least one circulating pump (6.1, 6.2), at least one heat exchanger (7.1 to 7.4) and at least one blower (8.1 and 8.4) for each heat exchanger (7.1 to 7.4), and a pumping capacity of the at least one circulating pump (6.1, 6.2) and/or a speed of each blower (8.1 and 8.4) can be controlled in dependence on the at least one control variable.

3. Fuel cell drive according to claim 1, characterized in that
the at least one control variable for cooling the fuel cells of each of the fuel cell units (3.1, 3.2) is at least a temperature of a coolant of the respective coolant circuit (5.1, 5.2) and/or at least a temperature of the respective fuel cell unit (3.1, 3.2).

4. Fuel cell drive according to one of claims 1 to 3, characterized in that
all components necessary for operating the fuel cell unit (1) and which are to be cooled with the exception of the fuel cells can be cooled with a low temperature cooling assembly which is independent from the fuel cell cooling assembly (2).

5. Fuel cell drive according to one of claims 1 to 4, characterized in that
a waste heat of the fuel cell cooling assembly (2) can be supplied to a heating circuit (10) of the motor vehicle.

6. Fuel cell drive according to one of claims 1 to 5, characterized in that
a number of electrical brake resistors (16.1, 16.2) for a brake of the vehicle can also be cooled by means of the fuel cell cooling assembly (2) or the low temperature cooling assembly.

7. Fuel cell drive according to one of claims 1 to 6, characterized in that
each of the fuel cell cooling units (4.1, 4.2) comprises a number of heat exchangers (7.1 to 7.4) which can be flown through by the coolant in parallel and one individual blower (8.1 and 8.4) for each of these heat exchangers (7.1 to 7.4) that can be activated individually.

8. Fuel cell drive according to claim 7, characterized in that
the heat exchangers (7.1 to 7.4) of each of the fuel cell cooling units (4.1, 4.2) can be connected to the respective coolant circuit (5.1, 5.2) individually and independently of each other.

9. Fuel cell drive according to claim 8, characterized in that
each of the heat exchangers (7.1 to 7.4) can be connected to a coolant circuit (5.1, 5.2) via an adjustable three-way valve (21.1, 21.2).

10. Fuel cell drive according to one of claims 1 to 6, characterized in that
each of the fuel cell cooling units (4.1, 4.2) comprises exactly one heat exchanger (7.1 to 7.4) and a number of blowers (8.1 and 8.4) that can be activated individually and independently of each other.
